(19) United States
(12) Patent Application Publication
(10) Pub. No.: US 2022/0395414 A1
(43) Pub. Date: Dec. 15, 2022

(54) Control Unit

(71) Applicant: LINAK A/S, Nordborg (DK)

(72) Inventor: Brian Schewe, Sønderborg (DK)

(21) Appl. No.: 17/776,669

(22) PCT Filed: Nov. 16, 2020
(86) PCT No.: PCT/DK2020/000328

§ 371 Date: May 13, 2022

(30) Foreign Application Priority Data
Nov. 15, 2019 (DK) PA 2019 01343

(51) Int. Cl. A61G 7/10

(52) U.S. Cl. CPC A61G 7/1073; A61G 7/1017; A61G 7/1067; A61G 7/1019

(57) ABSTRACT

Control unit (7), especially for a patient lift (1) comprising a base (10) and a power supply (8), said power supply (8) is releasably mounted on the base (10), and comprising locking means for retaining the power supply (8) on the base (10). The locking means comprises a set of slots and protrusions (17,18;20,22) on the base (10) and the power supply (8) and where the protrusions and slots engage each other, when the base (10) and the power supply (8) is displaced sideways in relation to each other. A tab (27) is arranged on an arm (24) of the locking handle (23). The tab (27) goes into the gap (28) between the base (10) and the power supply (8), when the locking handle (23) is locked. Thus, the protrusions (17,20) and slots (18,22) are in engagement with each other and at the same time functioning as a locking mechanism.

The present invention relates to a control unit, especially for electrically driven linear actuator systems comprising a base and a box, said box is releasably mounted on the base, and comprising locking means for retaining the box on the base. Linear actuator systems are used in many different applications such as patient lifts, adjustable articles of furniture, hospital beds, patient supports, treatment tables, chairs and the like for adjusting the position of an element.

Such a control unit is known from DE 10 2008 056 982 A1 to Dewert Antriebsund Systemtechnik GmbH. Here, the base is a rail to which the control unit is mounted by means of screws. The control unit is located in a separate housing and comprises a plug. The box containing the rechargeable batteries has a recess with a socket mating the plug of the control unit. The box with rechargeable batteries can be slid along the rail to connect it to the control unit and is kept in place by the mating plug and socket and a releasable connection to the rail.

The object of the present invention is to provide an improvement to the known control units.

This is achieved according to the invention in that the control unit comprises a base and a detachable power supply, where the base comprises a receiving area for receiving the power supply. The power supply comprises a housing and locking means which can be in a locked or unlocked position. The receiving area and the housing of the power supply comprises engagement means which can be in an engaged or disengaged state, where the engagement means is in the engaged state when the locking means is in the locked position.

In an embodiment, the engagement means comprises at least one slot and at least one protrusion, and where the protrusion and slot engage with each other when the locking means is in the locked position.

In an embodiment of the control unit, the receiving area has an end wall configured as a seat with at least one protruding cam, and the bottom of the housing of the power supply comprises at least one recess adapted for engagement with the at least one cam.

In an embodiment, the housing of the power supply comprises a front housing part and a rear housing part, where the rear housing part is accommodated in the receiving area, when the power supply is connected to the base. This helps to guide the end of the power supply on the protruding cams and eases the positioning of the power supply in the base.

In an embodiment, the receiving area comprises an arched section at the upper end of the bottom, and where the rear side of the housing of the power supply comprises a cavity adapted to accommodate the arched section.

In an embodiment, the rear housing part comprises a protrusion on an upper end of the side of the rear housing part, where the receiving area comprises an end wall, two side walls and a bottom. The side wall comprises a slot for engagement with the protrusion. This, among others, helps positioning the power supply in the receiving area. When the power supply is located in the receiving area, it cannot dislocate as it is caught between the two side walls, the seat and the arched section.

In an embodiment, the arched section comprises a protrusion extending from the side of the arched section facing the side wall of the receiving area, and where the cavity comprises a slot in a side wall of the cavity for engagement with the protrusion. This provides a good anchoring of the power supply in the base. Thus, the pair of slot and protrusion is inverse relative to the first pair mentioned. This brings about a good and stable securing of the power supply.

In an embodiment, the difference between the distance between the two side walls and the width of the rear housing part corresponds to at least the height of the protrusions. This results in a relative tight fitting between the base and the power supply. When the power supply has been inserted into the base, the top of it tilts a bit to the side.

In an embodiment, the locking means comprises a U-shaped locking handle comprising arms, which are pivotally journaled at either side of the housing of the power supply. This eases the handling of the power supply, when it is inserted or removed from the base.

In an embodiment, the arm of the locking handle comprises a tap, where the control unit comprises a gap formed between the side wall and the side of the rear housing part facing the side wall, and where the tap engages the gap when the locking handle is in its locked position. Thus, the means for positioning and locking the power supply is always at hand and is operated by the locking handle. When operating the locking handle, the protrusions and slots are brought in engagement with each other by displacing the power supply sideways. This is a reliable and secure way to bring protrusions and slots in engagement with each other and at the same time functioning as a lock.

In an embodiment, the locking handle comprises an axle journal on the arms, the axle journal comprising a first part with a first diameter, a second part with a second diameter, which is smaller than the first diameter, and an end knob at the distal end of the axle journal, where the first housing part comprises a slit for receiving the first part of the axle journal, where the rear housing part comprises a slit for receiving the second part of the axle journal, and where the end knob engages the rear housing such that the axle journals are retained in the housing of the power supply.

In an embodiment, the locking handle comprises at least one protrusion on the inner side of the arms, where the front housing part comprises a groove formed as a track in which the at least one protrusion can travel, said protrusion acting as an end stop for the turning of the locking handle. Hereby, uncontrolled movements of the locking handle are prohibited.

The invention further relates to a linear actuator system comprising an electric linear actuator, an operating unit, and the control unit.

The invention further relates to a patient lift comprising the linear actuator system.

The control unit according to the invention will be described more fully below with reference to the accompanying drawings, in which:

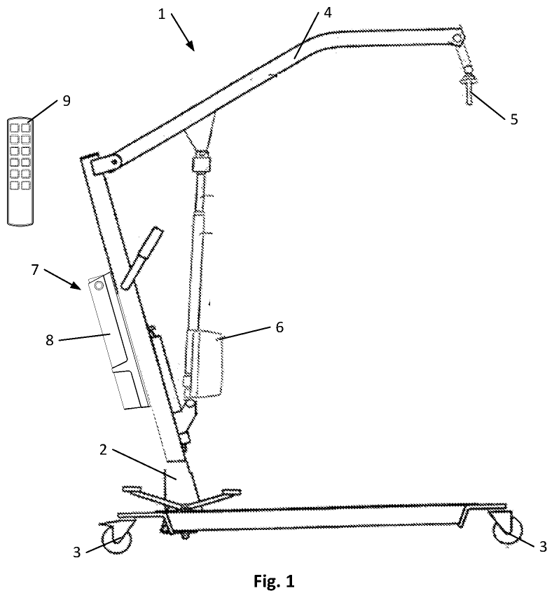

FIG. 1, a patient lift comprising a linear actuator system with an emergency stop,

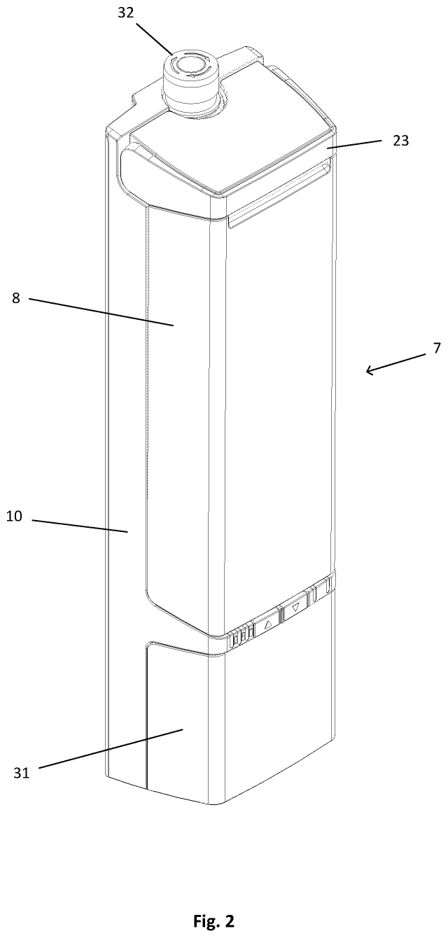

FIG. 2, a perspective view from the front of the control unit,

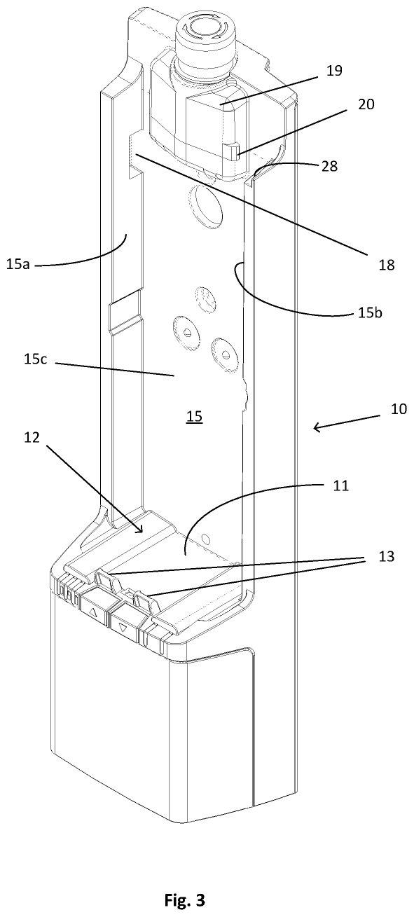

FIG. 3, a perspective view of the control unit in FIG. 2 without the detachable box with the power supply,

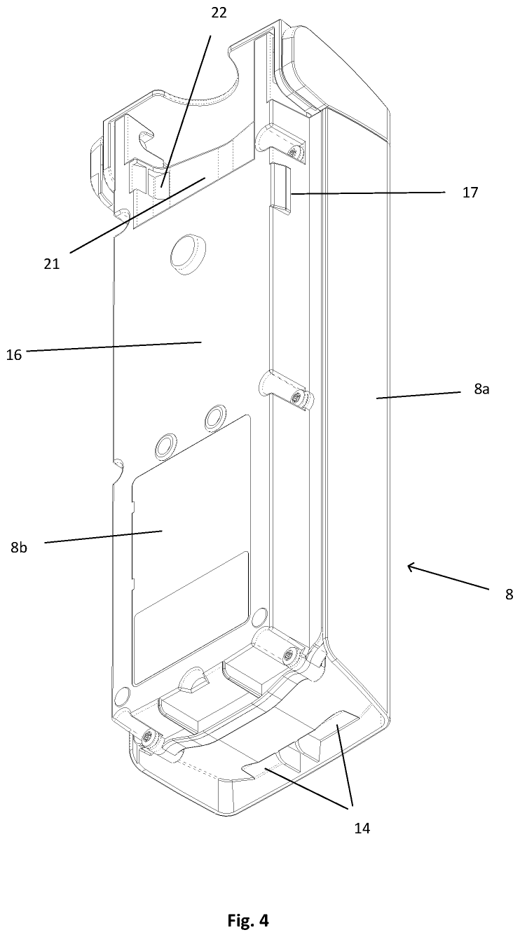

FIG. 4, a perspective view from the rear side of the control unit in FIG. 2,

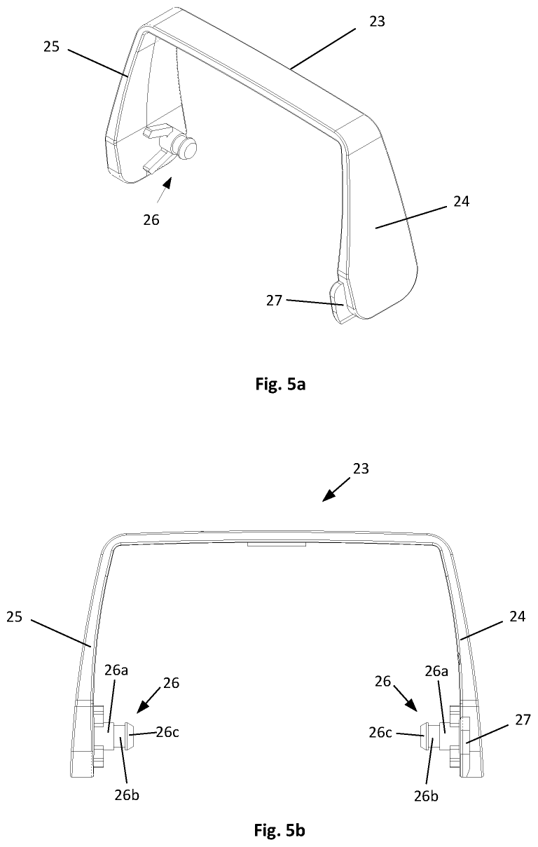

FIG. 5a, a perspective view of the handle of the control unit,

FIG. 5b, a bottom view of the handle of the control unit,

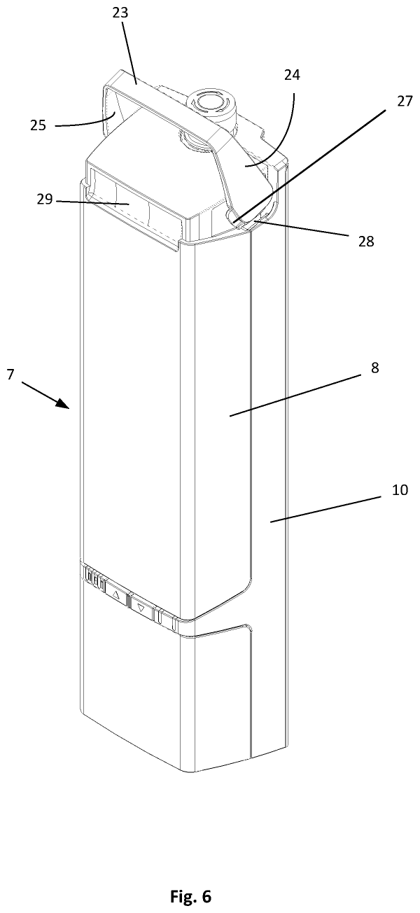

FIG. 6, a perspective view from the front of a control unit with the handle in an unlocked position,

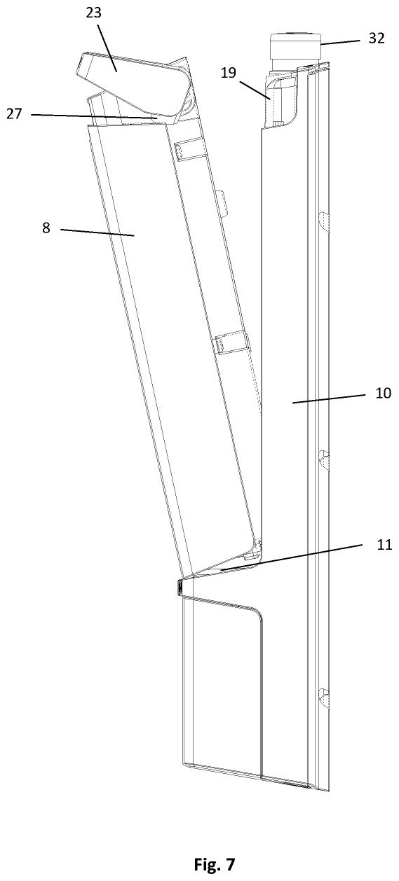

FIG. 7, a side view of the control unit with the box with the power supply under dismantling,

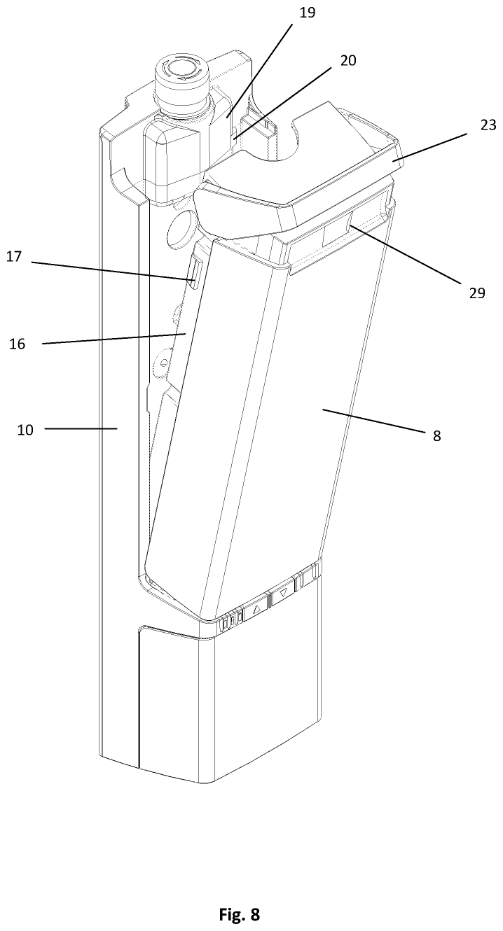

FIG. 8, same as in FIG. 7, however seen in perspective from the front,

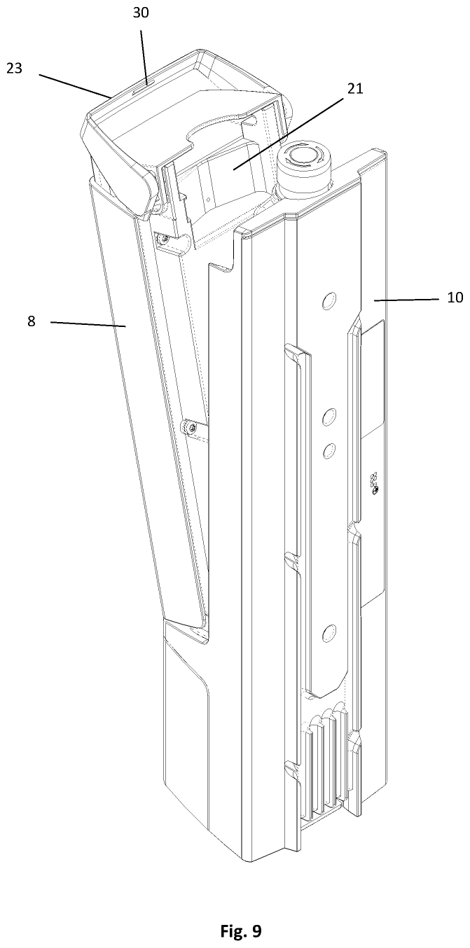

FIG. 9, same as in FIG. 7, however seen in perspective from the rear,

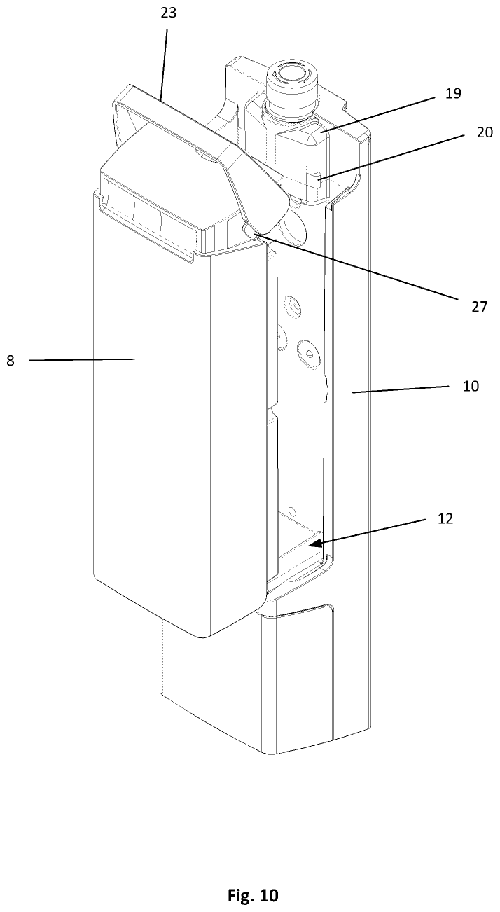

FIG. 10, a perspective view from the front of the control unit with dismantled box with the power supply,

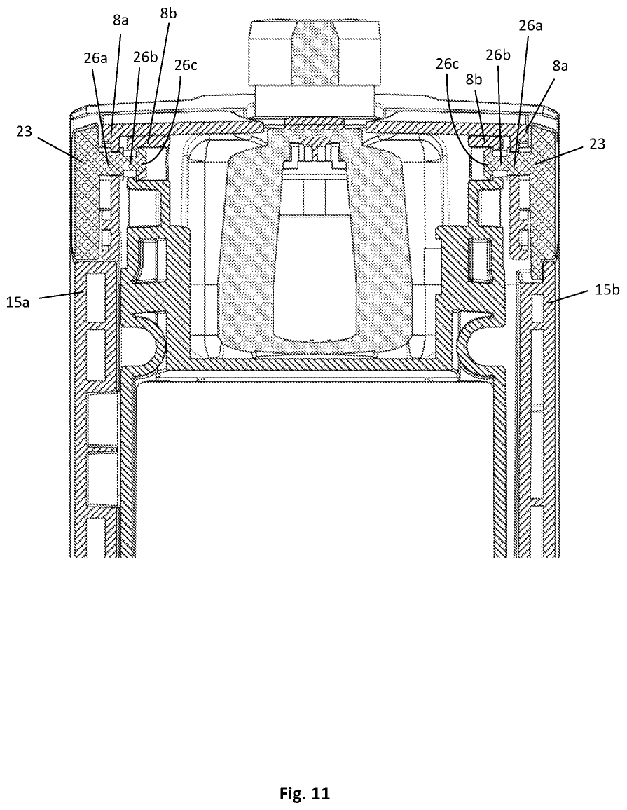

FIG. 11, a cross section showing the axle journal in engagement with the housing, and

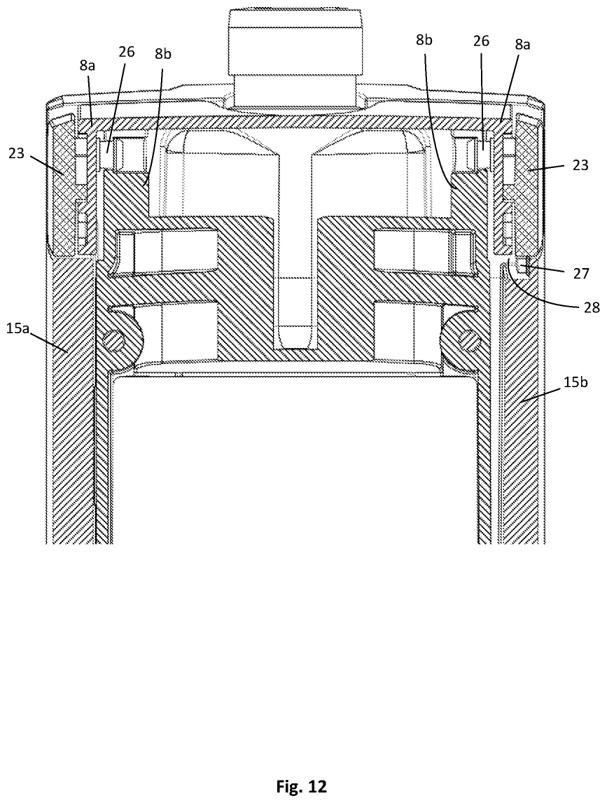

FIG. 12, a cross section showing the tap of the locking handle in engagement with the gap.

FIG. 1 shows a patient lift 1 comprising a frame 2 equipped with drive wheels 3. A cantilever 4 pivotable around a horizontal axis is with one end secured to the frame 2. To the other end of the cantilever 4, a lifting hook 5 for lifting a patient is secured. The patient lift 1 comprises an electric linear actuator system having an electric linear actuator 6, a control unit 7 with a controller, a power supply 8 having a housing fitted with rechargeable batteries and an operating unit 9. The cantilever 4 can be raised and lowered by means of the linear actuator 6, which with one end is secured to the frame 2 and with the other end is secured to the cantilever 4.

The housing of the power supply is constituted by a front housing part 8a and a rear housing part 8b. The power supply 8 is detachably connected to a base 10 of the control unit 7. The base 10 has a receiving area 15 outlined by an end wall 11, two side walls 15a,15b and a bottom 15c. The end wall 11 is configured as a seat 12 with a pair of protruding cams 13, adapted for engagement with a pair of recesses 14 in the bottom of the power supply 8. The power supply 8 is connected to the base 10 by placing the bottom of the housing of the power supply 8 onto the seat 12 at an angle relative to the seat, such that the protruding cams 13 engage the recesses 14 and such that the rear side 16 of the housing of the power supply 8 faces the bottom 15c of the receiving area 15. Subsequently, the power supply 8 can be tilted towards the base and into the receiving area 15. Hereby, most of the rear housing part 8b of the power supply 8 will be accommodated in the receiving area 15.

The rear housing part 8b has a protrusion 17 at the upper end on the side wall facing the side wall 15a of the receiving area 15 for engagement with a slot 18 in the side wall 15a.

At the upper end of the receiving area 15, there is an arched section 19. A protrusion 20 extends from the side of the arched section 19 facing the side wall 15b of the receiving area 15. At the top of the rear housing part 8a, the power supply 8 has a cavity 21 for accommodating the arched section 19, when the power supply 8 is tilted towards the base and into the receiving area 15. The protrusion 20 is adapted for engagement with a slot 22 in a side wall of the cavity 21.

The distance between the two side walls 15a and 15b is slightly larger than the width of the rear housing part 8b, more precisely the difference between the two corresponds to a little more than the height of the protrusions 17,20, respectively on the rear housing part 8b and on the arched section 19. When the power supply 8 is placed in the receiving area 15 and moved from the side wall 15b towards the side wall 15a, the protrusions 17 and 20 would engage the slots 18 and 22, respectively.

On the upper end of the power supply 8, there is a U-shaped locking handle 23 with the arms 24,25 pivotally journaled at either side of the housing of the power supply 8. Thus, each arm 24,25 has an axle journal 26. A first part 26a of the axle journal 26 fits into a slit of the front housing part 8a of the power supply 8. A second part 26b of the axle journal 26, which has a smaller diameter than the first part 26a, fits into a slit of the rear housing part 8b of the power supply. The distal end of the axle journal 26 has an end knop 26c engaging the slit of the rear housing part 8b, such that the locking handle 23 is pivotably retained in the housing of the power supply 8. At the end of the arm 24 of the locking handle 23, there a is a tap 27 adapted for engaging the gap 28 formed between the side wall 15b and the side of the rear housing part 8b facing the side wall 15b. To ensure sufficient space for the tap 27, a part of the side wall 15b has been cut off such that the gap 28 is wedge-shaped towards the bottom 15c of the receiving area 15. When the locking handle 23 is turned towards its locked position, the engagement between the wedge-shaped gap 28 and the tap 27 causes the housing of the power supply 8 to be pushed towards the side wall 15a of the receiving area 15. Hereby, the protrusions 17 and 20 are pushed into engagement with the slots 18 and 22. This engagement is kept as long as the locking handle 23 is in the locked position, because tap 27 takes up the entire space of the gap 28. In an alternative embodiment, the tap 27 could be wedge-shaped instead of the gap 28. When the locking handle 23 is turned to an unlocked position, the tap 27 is moved out of the gap 28.

The front of the front housing part 8a has, at the upper end, an indentation 29 adapted for engagement with the protrusion 30 for the locking handle 23. The indentation 29 and the protrusion 30 form a snap lock connection which can retain the locking handle 23 in a locked position, when they are engaging. In this position, the protrusions 17 and 20 fully engage with the slots 18 and 22. The power supply 8 cannot be detached from the base 10 as an outwards movement of the power supply 8 away from the base 10 is prohibited, since it requires a sideways movement between the protrusions 17,20 and the slots 18,22. Hence, the detachment of the power supply 8 and (dis)engagement between the protrusions 17,20 and slots 18,22 requires two different movements which are perpendicular to each other. Thus, the power supply 8 is prevented from unintentionally being detached from the base 10 when the locking handle 23 is in the locked position. As the rechargeable batteries are somewhat heavy, the locking handle 23 is convenient for the user when the power supply 8 is removed, e.g. for charging or replacement of the power supply.

On the base 10 at the opposite end of the power supply 8, there is a compartment under the cover 31 mounted on the base 10. This compartment contains the plugs for connecting e.g. the electric linear actuator 6 and operating unit 9 to the control unit 7.

In case of an emergency, e.g. during movement of a person in the patient lift, there is an emergency stop switch 32 located at the top of the control unit 7.

The base 10 of the control unit 7 is mounted by means of screws using screw holes from the front of the base, and that the rear side of the base 10 is provided with cable tracks for arranging the wired connections on the control unit 7.

It should be understood that the invention is not limited to the above embodiment of a control unit with a power supply on a patient lift. The power supply could be designed to contain other electric equipment, e.g. the controller. The control unit could also be designed with a base with two power supplies placed side by side. Moreover, the power supply could also be designed to be mounted on a linear actuator.

1. A control unit comprising a base (10) and a detachable power supply (8), where the base (10) comprises a receiving area (15) for receiving the power supply (8),
where the power supply (8) comprises a housing (8a, 8b) and locking means which can be in a locked or unlocked position,
the receiving area (15) and the housing (8a, 8b) of the power supply (8) comprise engagement means which can be in an engaged or disengaged state,
and where the engagement means is in the engaged state when the locking means is in the locked position.

2. The control unit according to claim 1, wherein the engagement means comprises at least one slot (18,22) and at least one protrusion (17,20), and where the protrusion (17,20) and slot (18,22) engage with each other when the locking means is in the locked position.

3. The control unit according to claim 1, wherein the receiving area (15) has an end wall (11) configured as a seat (12) with at least one protruding cam (13) and where the bottom of the housing of the power supply (8) comprises at least one recess (14) adapted for engagement with the at least one cam (13).

4. The control unit according to claim 1, wherein the housing of the power supply (8) comprises a front housing part (8a) and a rear housing part (8b), where the rear housing part (8b) is accommodated in the receiving area (15) when the power supply (8) is connected to the base (10).

5. Control unit according to claim 1, wherein the receiving area (15) comprises an arched section (19) at the upper end of the bottom (15c), and where the rear side of the housing (8b) of the power supply (8) comprises a cavity (21) adapted to accommodate the arched section (19).

6. Control unit according to claim 1, wherein the rear housing part (8b) comprises a protrusion (17) on an upper end of the side of the rear housing part (8b), where the receiving area (15) comprises an end wall (11), two side walls (15a, 15b) and a bottom (15c), and where the side wall (15a) comprises a slot (18) for engagement with the protrusion (17).

7. Control unit according to claim 1, wherein the arched section (19) comprises a protrusion (20) extending from the side of the arched section (19) facing the side wall (15b) of the receiving area (15), and where the cavity (21) comprises a slot (22) in a side wall of the cavity (21) for engagement with the protrusion (20).

8. Control unit according to claim 1, wherein the difference between the distance between the two side walls (15a) and (15b) and the width of the rear housing part (8b) corresponds to at least the height of the protrusions (17,20).

9. Control unit according to claim 1, wherein the locking means comprises a U-shaped locking handle (23) comprising arms (24,25) which are pivotally journaled at either side of the housing of the power supply (8).

10. Control unit according to claim 1, wherein the arm (24) of the locking handle (23) comprises a tap (27), where the control unit comprises a gap (28) formed between the side wall (15b) and the side of the rear housing part (8b) facing the side wall (15b), and where the tap (27) engages the gap (28) when the locking handle (23) is in its locked position.

11. Control unit according to claim 1, wherein the front of the front housing part (8a) comprises an indentation (29) at the upper end thereof, and where the locking handle (23) comprises a protrusion (30) adapted for locking engagement with the indentation (29).

12. Control unit according to claim 1, wherein the locking handle (23) comprises at least one protrusion on the inner side of the arms (24,25), where the front housing part (8a) comprises an indentation formed as a track in which the at least one protrusion (30) can travel, said protrusion forming an end stop for the turning of the locking handle (23).

13. Control unit according to claim 9, wherein locking handle (23) comprises an axle journal (26) on the arms (24,25), the axle journal (26) comprising a first part (26a) with a first diameter, a second part (26b) with a second diameter which is smaller than the first diameter, and an end knob (26c) at the distal end of the axle journal (26), where the first housing part (8a) comprises a slit for receiving the first part (26a) of the axle journal (26), where the rear housing part (8b) comprises a slit for receiving the second part (26b) of the axle journal (26), and where the end knob (26c) engages the rear housing (8b) such that the axle journals (26) are retained in the housing of the power supply (8).

14. A linear actuator system comprising an electric linear actuator (6), an operating unit (10), and a control unit (7) according to claim 1.

15. A patient lift (1) comprising a linear actuator system according to claim 14.
